(19) United States
(12) Patent Application Publication
(10) Pub. No.: US 2010/0136323 A1
(43) Pub. Date: Jun. 3, 2010

(54) SYSTEM FOR THERMAL PROTECTION AND DAMPING OF VIBRATIONS AND ACOUSTICS

(75) Inventors: Kripa Kiran Varanasi, Clifton Park, NY (US); Farshad Ghasripoor, Scotia, NY (US); Tao Deng, Clifton Park, NY (US); Bala Corratiyil, Cincinnati, OH (US); Nitin Bhate, Rexford, NY (US); Thomas Lowell Steen, Ballston Spa, NY (US); Sanket Sahebrao Mahajan, Nashik (IN)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/326,920

(22) Filed: Dec. 3, 2008

(51) Int. Cl. B32B 3/26

(52) U.S. Cl. 428/319.1; 428/304.4; 977/773

(57) ABSTRACT

A protective shield for a device exposed to heat includes a granular fill layer, a nano particle layer, a metallic foam layer, a thermal barrier coating, or combinations thereof. The shield is configured for providing thermal resistance, and damping of vibrations, and acoustics to the device.

### BACKGROUND

The invention relates generally to a protective shield, and more particularly to a protective shield for thermal protection and damping of vibrations and acoustics of a device, for example, a sump in an aircraft engine.

Reciprocating engines use either a wet-sump or dry-sump oil system. In an aircraft engine, the sump is an enclosure containing bearings and lubrication oil. In a dry-sump system, the oil is contained in a separate tank, and circulated through an engine using pumps. In a wet-sump system, the oil is contained in a sump, which is an integral part of the engine.

The main component of a wet-sump system is an oil pump, in which oil pump draws oil from a sump and routes it to an engine. The oil is routed to the sump after passing through the engine. In some engines, additional lubrication is provided by a rotating crankshaft, in which crankshaft splashes oil onto portions of the engine. In a dry-sump system, an oil pump provides oil pressure, but the source of the oil is a separate oil tank, located external to an engine. After oil is routed through the engine, it is pumped from the various locations in the engine back to the oil tank using scavenge pumps.

The flash point of the lubrication oil in a sump is typically around 400 degrees Fahrenheit. The air outside the sump in an aircraft engine can reach temperatures around about 700 degrees Fahrenheit, significantly higher than the flash point of the lubrication oil. Cooling air from one or more compressor stages may be circulated around the sump to maintain the temperature of the sump lower than the flash point of the lubrication oil. However, as engines with higher thrust are manufactured, the temperature of the air that is fed from the compressor stages also increases making it difficult to cool the sump.

It is desirable to provide a system for thermally protecting the sump so as to maintain the temperature of a sump lower than the flash point of the lubrication oil contained in the sump.

### BRIEF DESCRIPTION

In accordance with one exemplary embodiment of the present invention, a protective shield for a device exposed to heat includes a granular fill layer, a nano particle layer, a metallic foam layer, a thermal barrier coating, or combinations thereof. The shield is configured for providing thermal resistance, and damping of vibrations, and acoustics to the device.

In accordance with another exemplary embodiment of the present invention, a sump having a protective shield disposed around an outer surface of an enclosure configured to contain lubrication oil is disclosed.

In accordance with another exemplary embodiment of the present invention, a protective shield for a sump configured to contain lubrication oil is disclosed. The shield includes a nano particle layer provided on an outer surface of the sump.

In accordance with another exemplary embodiment of the present invention, a protective shield for a sump configured to contain lubrication oil is disclosed. The shield includes a metallic foam layer provided on an outer surface of the sump.

In accordance with another exemplary embodiment of the present invention, a protective shield for a sump configured to contain lubrication oil is disclosed. The shield includes a thermal barrier coating provided on an outer surface of the sump.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an engine having a sump with a protective shield in accordance with an exemplary embodiment of the present invention;

FIG. 2 is a diagrammatical representation of a sump provided with a protective shield having a granular fill layer or nano particle layer in accordance with an exemplary embodiment of the present invention;

FIG. 3 is a diagrammatical representation of a sump provided with a protective shield having a metallic foam in accordance with an exemplary embodiment of the present invention;

FIG. 4 is a diagrammatical representation of a sump provided with a protective shield having a thermal barrier coating in accordance with an exemplary embodiment of the present invention; and

FIG. 5 is a diagrammatical representation of a sump provided with a protective shield having plurality of insulation layer in accordance with an exemplary embodiment of the present invention.

### DETAILED DESCRIPTION

As discussed in detail below, embodiments of the present invention comprise a system and method for thermal protection and damping of vibrations and acoustics. A protective shield includes a granular fill layer, or nano particle layer, or a metallic foam layer, or a thermal barrier coating, or combinations thereof. Although the embodiments discussed herein relate to a sump in an aircraft engine, it is also suitable for other applications including steam turbine applications, gas turbine applications, or the like. It should also be noted herein that the protective shield is also applicable for any other devices where thermal insulation is a concern. The approach involves providing a protective shield around a device, for example, a sump, so as to provide a high thermal resistance, thereby reducing the temperature inside the device. An outer side of the sump enclosure is insulated with a shield that includes ultra-low thermal conductivity materials with conductivities that are an order of magnitude lower than traditional insulation materials. This will result in a high thermal resistance in the heat path and lead to a significant reduction in the temperature inside the sump. Additionally the protective shield also provides damping of vibrations and acoustics to the device.

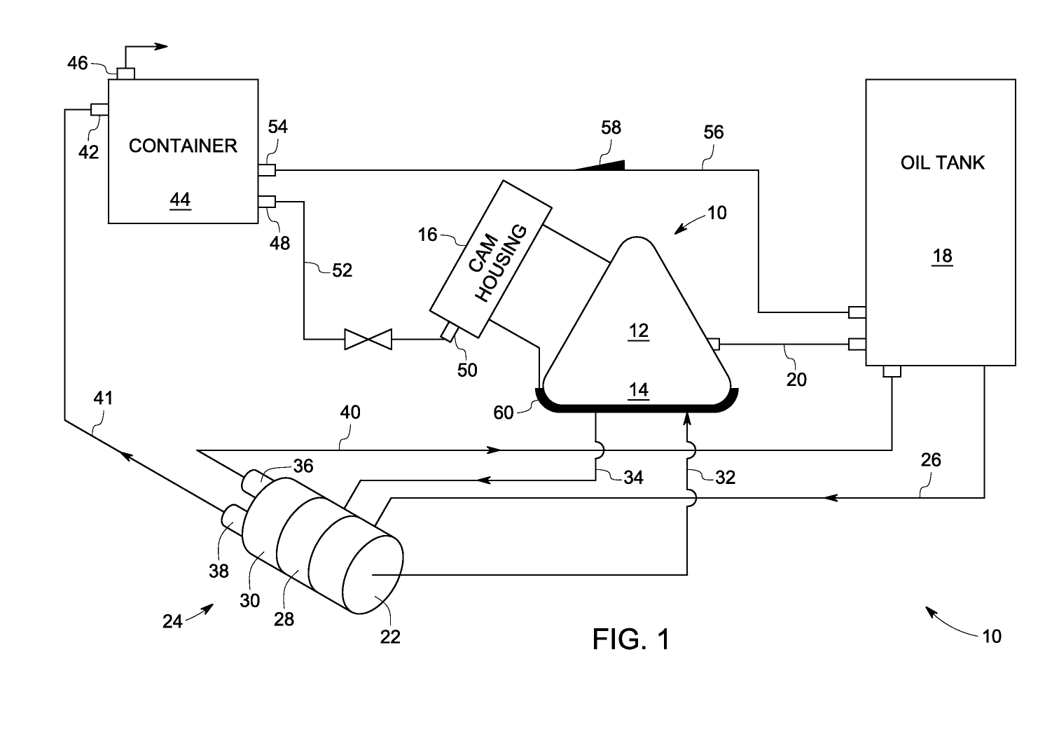

Referring now to FIG. 1, an exemplary engine 10 is illustrated. The engine 10 includes a crankcase 12 with a sump 14 provided in a lower portion thereof. The engine 12 may include a race engine, aircraft engine, or the like. The engine 10 also includes a cam housing 16 and an oil tank 18 located externally to the crankcase 12. The oil tank 18 is typically relatively small and only needs to have sufficient capacity to contain a quantity of oil to be supplied to the crankcase 12 for continuous lubrication of the engine 10.

The oil tank 18 is coupled to the crankcase 12 by a breather conduit 20. The tank 18 is coupled to a pressure pump section 22 of a pump and air separator assembly 24 via a conduit 26. The assembly 24 further includes a scavenger pump section 28, and an air separator section 30. Oil is returned to the sump 14 from the pressure pump section 22 via a conduit 32. Oil including entrained air is fed to the scavenger pump section 28 via a conduit 34. The scavenger pump section 28 supplies oil to the air separator 30. The air separator 30 is provided with two outlets 36 and 38 for exit of the separated oil and air respectively. Oil flows from the outlet 36 back to oil tank 18 through a conduit 40.

The separated air flows from the outlet 38 to an inlet 42 of a canister or container 44 via a conduit 41. The container 44 is provided with a vent 46 for venting the container 44 to the atmosphere. The container 44 is also provided with an oil outlet 48 located proximate to a bottom of the container 44. Oil that is condensed out of the separated air in the container 44, may be returned to an inlet 50 of the cam housing 16 via a conduit 52. In the illustrated preferred embodiment, the connection is made on cam housing 14. The oil tank 18 is also coupled to an inlet 54 of the container 44 via a conduit 56 provided with a pressure relief valve 58. It should be noted herein that configuration of the engine 10 may vary depending on the application.

Referring now again to the sump 14, a protective shield 60 is applied to the sump 14. The shield 60 is configured to provide a high thermal resistance, thereby reducing the temperature inside the sump 14. Additionally the protective shield 60 also provides damping of vibrations and acoustics to the sump 14. It should be noted that even though the application of the protective shield 60 is discussed with reference to the sump 14 of the engine 10, the shield 60 is equally applicable to other devices where thermal insulation is a matter of concern. The details of the shield 60 are discussed in greater detail with reference to subsequent figures.

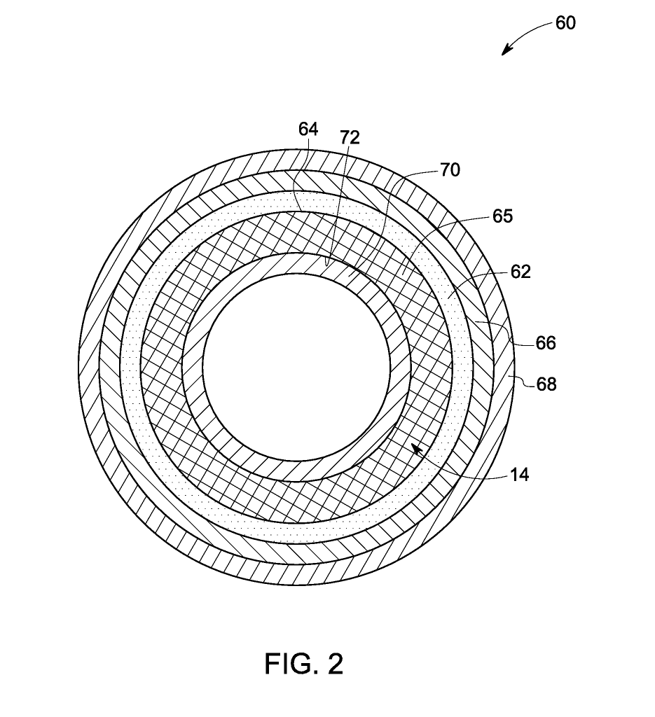

Referring to FIG. 2, a protective shield 60 in accordance with an exemplary embodiment of the present invention is illustrated. The protective shield 60 is provided around the sump 14. In the illustrated embodiment, the shield 60 includes a layer 62 provided between an outer surface 64 of the sump enclosure 65 and a metallic casing 66. In one embodiment, the layer 62 may be a granular fill layer. The granular fill layer may include sand, lead shots, steel balls, or the like. Thermal resistance and significant damping of structural vibration can be attained by coupling a low-density medium such as granular particles in which the speed of heat, vibration, and sound propagation is relatively low. It should be noted herein that granular material such as sand can be modeled as a continuum, and that thermal resistance and damping in a structure filled with such a granular material can be increased so that standing waves occur in the granular material at the resonant frequencies of a structure. A low-density granular fill material can provide high damping of structural vibration over a broad range of frequencies.

In another embodiment, the layer 62 may be a nano particle layer. The nano particle layer may include ceramic particles, polymeric particles, or combinations thereof having relatively low thermal conductivity. The ceramic particles include but are not limited to ceramic oxide, ceramic carbide, ceramic nitride, or combinations thereof. Most of these ceramic materials have relatively high melting points (e.g. higher than 1500 degrees Celsius) and hence will be suitable for high temperature applications. Ceramic oxide includes silicon oxide, titanium oxide, aluminum oxide, magnesium oxide, yttrium oxide, zirconium oxide, yttrium stabilized zirconium, or combinations thereof. It should be noted herein that material properties at the nano level are different than those at the macro level. For example, in case of carbon nanotubes (CNTs), their axial thermal conductivity is more than an order of magnitude higher than that of bulk carbon.

The main reason for this is the peculiar geometry of CNTs, which geometry allows for ballistic transport of heat along the axial direction. In contrast, reducing the feature size for a material may cause a reduction in a particular property. For example, using nanoparticles in lieu of micron-sized or bigger particles may help decrease the thermal conduction in a system for certain materials. In addition, one factor affecting the thermal transport in a system of nanoparticles is believed to be the increase in surface area to volume ratio for a nanoparticle compared to a micron-sized or bigger particle. Due to the increased surface area to volume ratio, the nano-particulate system would exhibit comparatively higher resistance to thermal transport. This is caused by the increase in number of interfaces between the particles and the matrix and, among the particles themselves.

Hence, using coating materials which have nanoparticles embedded in a matrix have potential applications as thermal barriers. For thermal barrier applications the coating materials may be non-metallic. In such materials, the heat is transported by phonons (analogous to electrons in electrical transport). Phonons typically have a large variation in their frequencies and mean-free-paths (mfps). However, the bulk of the heat is carried out by phonons with mfps in the range between about 1 to about 100 nm at room temperature. Mean-free-path is defined as the distance a phonon travels before it collides with something else such as the lattice or an impurity. Hence, it has a significant impact on the thermal conduction through them. In one embodiment, a low temperature liquid assisted, spray process is used to deposit nano particles on the surface of the sump enclosure. It should be noted herein that the nano particle layer might be formed by various techniques including liquid phase wetting, chemical vapor deposition, sintering, annealing, or combinations thereof.

The thermal resistance along the metallic casing 66 is relatively lower than across the layer 62 into the sump 14. The metallic casing 66 may include but is not limited to iron, titanium, copper, zirconium, aluminum, and nickel. As a result heat conducts slower across the layer 62 compared to that along the metallic casing 66, thereby creating an effective thermal shield. The layer 62 also facilitates damping of vibrations and acoustics of the sump 14.

In certain embodiments, the shield 60 may further include a super hydrophilic coating 68 provided on the metallic casing 66. The formation of the super hydrophilic coating 68 facilitates the formation of a water film on a surface of the coating 68 resulting in improved thermal resistance. The super hydrophilic coating 68 may be formed by various techniques including but not limited to texturing, grinding, shot peening, micromachining, grid blasting, coating, or combinations thereof. In some embodiments, the shield 60 may also additionally include an oleophilic coating 70 provided on an inner surface 72 of the sump 14. The formation of the oleophilic coating 70 facilitates formation of an oil film on a surface of the coating 70 thereby further improving the thermal resistance.

In certain embodiments, the shield 60 may not include the metallic casing 66. In such an embodiment, the layer 62 may be formed on the outer surface 64 of the sump 14 and the super hydrophilic coating 68 may be provided on a surface of the layer 62. In one embodiment, after the deposition of the particles on the enclosure 65, the nanoparticles are bound together only by Van der Waals interaction. Such nano structure can be sintered or annealed to induce necking or diffusion of materials at the contacts between the particles to improve the mechanical strength of the nano porous structures.

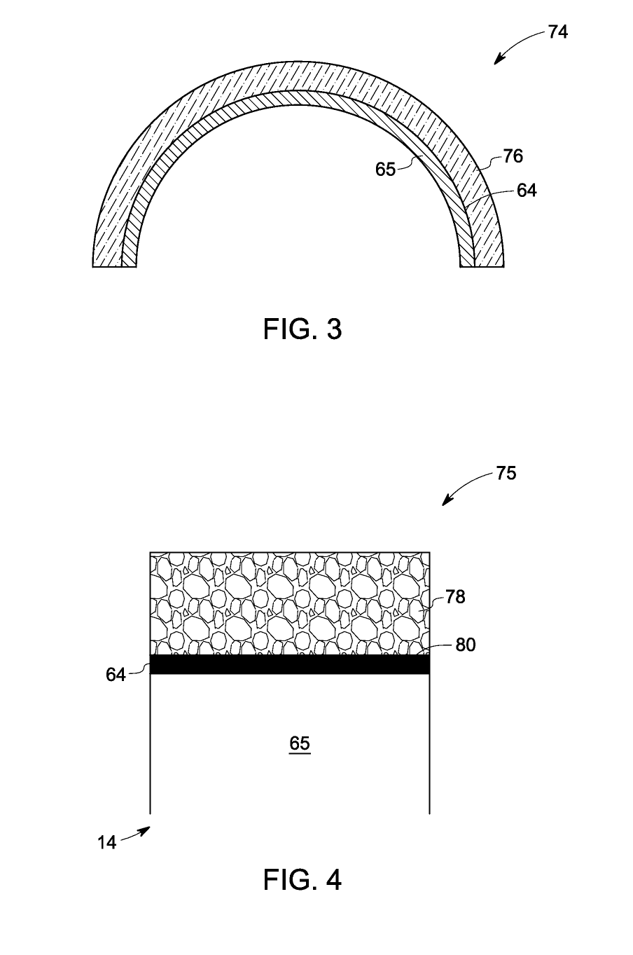

Referring to FIG. 3, a protective shield 60 in accordance with an exemplary embodiment of the present invention is illustrated. The protective shield 60 is provided around the sump 14. In the illustrated embodiment, the shield 60 includes a metallic foam layer 76 provided on the outer surface 64 of the sump enclosure 65. Thermal resistance and significant damping of structural vibration can be attained by coupling a low-density medium such as foam in which the speed of heat, vibration, and sound propagation is relatively low. The effective thermal conductivity is reduced due to the trapped air inside the foam layer 76.

In certain embodiments, the metallic foam layer 76 may be disposed between the outer surface 64 of the sump enclosure 65 and the metallic casing 66 (illustrated in FIG. 2). In some embodiments, the shield 60 may further include the super hydrophilic coating 68 (illustrated in FIG. 2) provided on the metallic casing. In certain embodiments, the shield 60 may not include the metallic casing 66. In the illustrated embodiment, the super hydrophilic coating 68 may be provided on a surface of the metallic foam layer 76.

Referring to FIG. 4, a protective shield 75 in accordance with an exemplary embodiment of the present invention is illustrated. In the illustrated embodiment, the shield 75 includes a thermal barrier coating 78 applied on the outer surface 64 of the sump enclosure 65 via a thermally grown oxide layer 80. Thermal barrier coating 78 such as ceramic coating is characterized by its low thermal conductivity. It should be noted herein that when the thermal barrier coating is applied to a surface of a component, thermal barrier coating induce a large temperature gradient as it is exposed to heat flow. In one embodiment, the thermal barrier coating 78 includes a yttria stabilized zirconium layer having a thickness of about 300 micro meters applied using a thermal spray process. The thermally grown oxide layer 80 provides oxidation resistance to the thermal barrier coating 78. In another embodiment, the thermal barrier coating 78 is formed by electron beam physical vapor deposition and may have thickness of about 120 micrometers. The electron beam physical vapor deposition technique involves heating an ingot of a coating material in a crucible and vaporized using a high power electron beam. The vapor deposits on a substrate surface rotatable above the vapor source.

In one embodiment, the thermal barrier coating 78 includes functionally graded materials. It should be noted herein that the concept of functionally graded materials is to create spatial variations in composition and/or microstructure that result in corresponding changes in material properties. By varying the composition of the thermal barrier coating 78 during the deposition process, the thermal barrier coating 78 that offers the desired thermal and mechanical properties at the coating surface can be deposited, while having an optimum thermal expansion match with the base material at the interface.

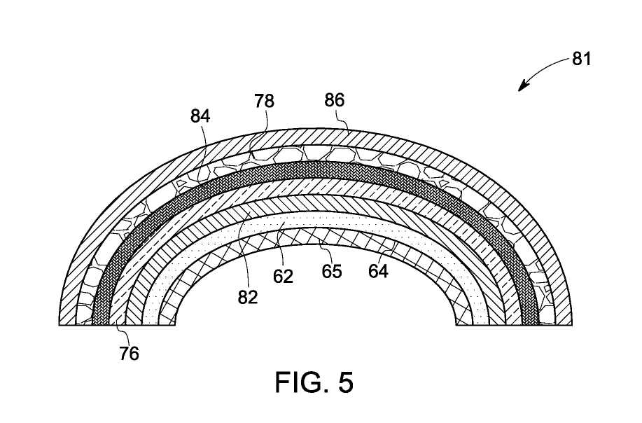

Referring to FIG. 5, a protective shield 81 in accordance with an exemplary embodiment of the present invention is illustrated. In the illustrated embodiment, the shield 81 includes a plurality of metallic insulation layers 82, 84, 86 disposed around the outer surface 64 of the sump enclosure 65. Even though 3 metallic insulation layers are illustrated in the embodiment, the number of metallic insulation layers may vary in other embodiments depending upon the application.

In the illustrated embodiment, the layer 62 (granular fill layer or nano particle layer) is disposed between the outer surface 64 of the sump enclosure 65 and the metallic insulation layer 82. The metallic foam layer 76 is disposed between the metallic insulation layers 82, 84. The thermal barrier coating 78 is disposed between the metallic insulation layers 84, 86. It should be noted herein that the illustrated embodiment should not be construed in an way as limiting the scope of the invention. The number of illustrated layers and their relative positions may vary depending on the application. All possible permutations and combinations are envisaged.

The embodiments discussed with reference to FIGS. 2-5, act both as a thermal shield and also as acoustic and vibration attenuator. All possible permutations and combinations of the embodiments discussed with reference to FIGS. 2-5 are also envisaged.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A protective shield for a device exposed to heat, comprising:
a granular fill layer, a nano particle layer, a metallic foam layer, a thermal barrier coating, or combinations thereof;
wherein the shield is configured for providing thermal resistance, and damping of vibrations, and acoustics to the device.

2. The shield of claim 1, wherein the device comprises a sump disposed in an aircraft engine; wherein the granular fill layer, nano particle layer, a metallic foam layer, a thermal barrier coating, or combinations thereof are provided on the sump.

3. The protective shield of claim 1, wherein the granular fill layer comprises sand, lead shots, steel balls, or combinations thereof.

4. The shield of claim 1, wherein the nano particle layer comprises ceramic particles, polymeric particles, or combinations thereof.

5. The shield of claim 4, wherein the ceramic particles comprises ceramic oxide, ceramic carbide, ceramic nitride, or combinations thereof.

6. The shield of claim 5, wherein the ceramic oxide comprises silicon oxide, titanium oxide, aluminum oxide, magnesium oxide, yttrium oxide, zirconium oxide, yttrium stabilized zirconium, or combinations thereof.

7. The shield of claim 5, wherein the thermal barrier coating comprises a ceramic coating.

8. The shield of claim 2, further comprising a super hydrophilic coating provided on the granular fill layer, nano particle layer, the metallic foam layer, the thermal barrier coating, or combinations thereof; wherein the super hydrophilic coating is configured to form a liquid film to provide thermal resistance.

9. The shield of claim 2, further comprising an oleophilic coating provided on an inner surface of the sump; wherein the oleophilic coating is configured to form an oil film to provide thermal resistance.

10. The shield of claim 1, further comprising a plurality of metallic insulation layers; wherein the granular fill layer, nano particle layer, the metallic foam layer, the thermal barrier coating, or combinations thereof are disposed between the plurality of metallic insulation layers.

11. A sump comprising:
a protective shield disposed around an outer surface of an enclosure configured to contain lubrication oil; wherein the shield is configured for providing thermal resistance, and damping of vibrations, and acoustics to the sump.

12. The sump of claim 11, wherein the protective shield comprises a granular fill layer, a nano particle layer, a metallic foam layer, a thermal barrier coating, or combinations thereof.

13. A protective shield for a sump configured to contain lubrication oil; the protective shield comprising:
a nano particle layer provided on an outer surface of the sump;
wherein the shield is configured for providing thermal resistance, and damping of vibrations, and acoustics to the sump.

14. The shield of claim 13, wherein the nano particle layer comprises ceramic particles, polymeric particles, or combinations thereof.

15. The shield of claim 14, wherein the ceramic particles comprises ceramic oxide, ceramic carbide, ceramic nitride, or combinations thereof.

16. The shield of claim 15, wherein the ceramic oxide comprises silicon oxide, titanium oxide, aluminum oxide, magnesium oxide, yttrium oxide, zirconium oxide, yttrium stabilized zirconium, or combinations thereof.

17. The shield of claim 13, further comprising a metallic casing, wherein the nano particle layer is disposed between the metallic casing and an outer surface of the sump.

18. The shield of claim 17, further comprising a super hydrophilic coating provided on the metallic casing; wherein the super hydrophilic coating is configured to form a liquid film to provide thermal resistance.

19. The shield of claim 13, further comprising a super hydrophilic coating provided on the nano particle layer; wherein the super hydrophilic coating is configured to form a liquid film to provide thermal resistance.

20. The system of claim 19, wherein the super hydrophilic coating is formed by texturing, grinding, shot peening, micromachining, grid blasting, coating, or combinations thereof.

21. The system of claim 13, wherein the nano particle layer is formed by liquid phase wetting, chemical vapor deposition, sintering, annealing, or combinations thereof.

22. The shield of claim 13, further comprising an oleophilic coating provided on an inner surface of the sump; wherein the oleophilic coating is configured to form an oil film to provide thermal resistance.

23. A protective shield for a sump configured to contain lubrication oil; the protective shield comprising:
a metallic foam layer provided on an outer surface of the sump;
wherein the shield is configured for providing thermal resistance, and damping of vibrations, and acoustics to the sump.

24. The shield of claim 23, further comprising a metallic casing, wherein the metallic foam layer is disposed between the metallic casing and an outer surface of the sump.

25. A protective shield for a sump configured to contain lubrication oil; the protective shield comprising:
at least one thermal barrier coating provided on an outer surface of the sump; wherein the at least one thermal barrier coating is formed by electron beam physical vapor deposition;
wherein the shield is configured for providing thermal resistance, and damping of vibrations, and acoustics to the sump.
